(19) United States
(12) Patent Application Publication
(10) Pub. No.: US 2026/0233565 A1
(43) Pub. Date: Aug. 13, 2026

(54) Vehicle Receiver Hitch Stowage Device and Method of Use

(71) Applicant: Philip Gieger, Aledo, TX (US)

(72) Inventor: Philip Gieger, Aledo, TX (US)

(21) Appl. No.: 19/050,884

(22) Filed: Feb. 11, 2025

(51) Int. Cl. B60D 1/52; B60D 1/36

(52) U.S. Cl. CPC B60D 1/52; B60D 1/36

(57) ABSTRACT

A vehicle receiver hitch stowage device and method of use are disclosed. The stowage device includes a rectangular steel plate with apertures for mechanical fastening to side wall of a truck bed. A cylindrical steel rod is welded perpendicularly to a center point of the plate and has an aperture near its proximal end for receiving a hitch pin to secure a receiver hitch. The plate's thickness is approximately 3/16 inches, each side measures about 5 inches, and the rod has a length of about 4 inches with a diameter of about 5/8 inches. The plate can be made from carbon or stainless steel and may have a textured surface with rounded vertices. The method of use involves fastening the plate to a vehicle surface, attaching the rod, placing the receiver hitch on the rod, and securing it with a hitch pin.

### TECHNICAL FIELD

The present disclosure relates to a vehicle receiver hitch stowage device and more particularly, to a stowage solution specifically designed for securely holding a receiver hitch within a pick-up truck bed or car trunk.

### BACKGROUND OF INVENTION

The following description includes information that may be useful in understanding the present disclosure. It is not an admission that any of the information provided herein is prior art or relevant to the present disclosure, or that any publication specifically or implicitly referenced is prior art.

Receiver hitches are essential components for vehicles used to tow trailers, campers, and other equipment. However, when not in use, the receiver hitches present a stowage challenge, particularly in vehicles such as pick-up trucks and cars with limited trunk space. When a receiver hitch is left unsecured in the bed of a truck or the trunk of a car, the receiver hitch can move around during transit. The movement can cause damage to both the hitch and the interior surfaces of the vehicle, including scratches, dents, and other forms of wear and tear.

A loose receiver hitch can pose a significant safety hazard. It can become a projectile in the event of sudden braking or an accident, potentially causing injury to vehicle occupants or damage to the vehicle. Also, without a designated stowage spot, the receiver hitch can contribute to clutter and disorganization within the vehicle. This makes it difficult for the driver to find and access the hitch when needed, leading to inconvenience and wasted time.

Furthermore, the noise and movement of an unsecured receiver hitch can be a source of distraction for the driver, compromising driving safety and focus. Existing stowage solutions may not provide easy access to the receiver hitch when it is needed. This can be particularly problematic for individuals who frequently use their hitches and require a quick and straightforward method to secure and remove the hitch. These shortcomings highlight the need for an improved and dedicated stowage device for receiver hitches that is designed to securely hold the hitch in place, preventing movement and reducing the risk of damage while providing easy accessibility for use.

### SUMMARY OF INVENTION

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In an aspect, the present disclosure relates to a vehicle receiver hitch stowage device. The device comprises a rectangular steel plate that includes a plurality of apertures positioned near its vertices. The apertures are designed to receive mechanical fasteners, allowing the plate to be securely attached to a vehicle surface, such as a truck bed or car trunk. A cylindrical steel rod is welded perpendicularly to the center of the steel plate. This rod features an aperture near its proximal end, which is specifically adapted to receive a hitch pin, thereby securing a receiver hitch in place. The steel plate has a thickness of approximately 3/16 inches, and each side of the plate measures about 5 inches. The cylindrical rod extends to a length of about 4 inches and has a diameter of approximately 5/8 inches.

The device can be made from various types of steel, including carbon steel and stainless steel. The surface of the steel plate may be textured to enhance grip and reduce slippage when installed. Furthermore, the vertices of the steel plate can be rounded to prevent injury during handling and installation. The cylindrical steel rod may be welded to the plate using gas tungsten arc welding, among other welding techniques.

In an exemplary embodiment, a method of using the vehicle receiver hitch stowage device is described. In the method, first, the planar metal plate is fastened to a side wall of a vehicle using mechanical fasteners. Next, the cylindrical rod is attached perpendicularly to a center point on the metal plate. Afterward, the receiver hitch is placed onto the cylindrical rod, and it is then secured by passing a hitch pin through the aperture near the proximal end of the rod. This method ensures that the receiver hitch is securely held in place within the vehicle, preventing movement and potential damage.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The embodiments of the disclosure itself, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 illustrates an elevated view of vehicle receiver hitch stowage device 100 in an assembled form according to an embodiment of the present invention.

FIG. 2 illustrates a side perspective view of the vehicle receiver hitch stowage device 100 of the present invention without the hitch pin according to an embodiment of the present invention.

FIG. 3 is a top view of the vehicle receiver hitch stowage device of the vehicle receiver hitch stowage device of the present invention in the assembled form.

FIG. 4 is a side elevation view of the vehicle receiver hitch stowage device in the assembled form according to an embodiment.

FIG. 5 illustrates a standalone view of the metal plate used in the vehicle receiver hitch stowage device 100 of the present invention;

FIG. 6 illustrates a perspective view showing the vehicle receiver hitch stowage device mounted to an inside wall of a truck bed stowing a receiver hitch in accordance with one embodiment.

FIG. 7 illustrates a flow chart depicting a process of mounting and using the vehicle receiver hitch stowage device 100 according to one embodiment of the present invention.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprise”, “comprising”, “include(s)”, or any other variations thereof, are intended to cover a non-exclusive inclusion, such that a setup, system or method that comprises a list of components or steps does not include only those components or steps but may include other components or steps not expressly listed or inherent to such setup or system or method. In other words, one or more elements in a system or apparatus proceeded by “comprises… a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

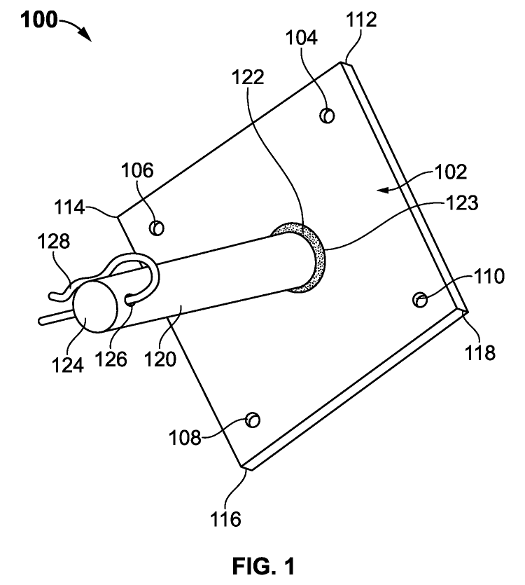

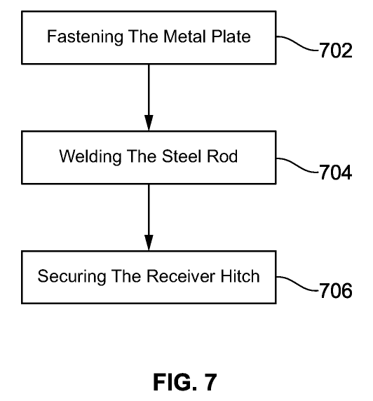

Reference will now be made to the exemplary embodiments of the disclosure, as illustrated in the accompanying drawings. Wherever possible, same numerals will be used to refer to the same or like parts. Embodiments of the disclosure are described in the following paragraphs with reference to FIG. 1 – FIG. 7.

FIG. 1 illustrates an elevated view of vehicle receiver hitch stowage device 100 of the present invention in an assembled form according to an embodiment of the present invention. The vehicle receiver hitch stowage device 100 of the present invention is adapted to store a receiver hitch in a pick-up truck bed or car trunk. The vehicle receiver hitch stowage device 100 includes a generally square or rectangular planar metal plate 102. Preferably, the plate 102 is made of steel which can be one of carbon steel, stainless steel or any other durable and corrosion-resistant steel. A plurality of apertures 104,106,108,110 are disposed in the plate 102 and are preferably positioned near the vertices 112,114,116,118 of the plate 102. The apertures 104,106,108,110 are configured to receive mechanical fasteners for screwing the metal plate 102 to the pick-up truck bed or car trunk.

A cylindrical steel rod 120 is attached to the center point 122 of the plate 102 and is preferably welded for a secure integration with the plate 102. The cylindrical steel rod 120 is positioned transverse or perpendicular to the metal plate 102 and is not pivotable. Preferably, the steel rod 120 has an elongated length of about 4 inches extending between the fixed end 123 and the proximal end 124. An aperture 126 is disposed in the steel rod 120 near the proximal end 124 and the aperture 126 is adapted to receive a hitch pin 128 therethrough to hold a receiver hitch as illustrated and described later in the disclosure.

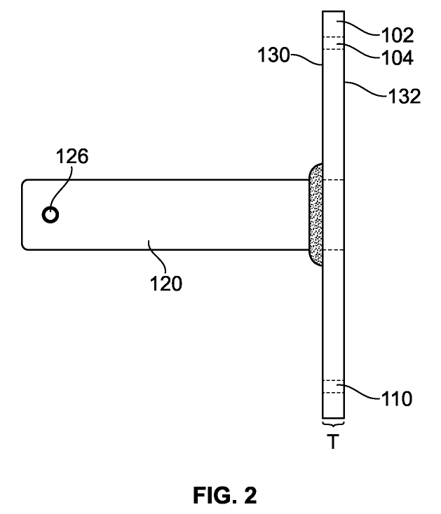

FIG. 2 illustrates a side perspective view of the vehicle receiver hitch stowage device 100 of the present invention without the hitch pin according to an embodiment of the present invention. As illustrated, the cylindrical steel rod 120 is perpendicular to the metal plate 102 and is welded to the front surface 130 of the plate 102. When the vehicle receiver hitch stowage device 100 is placed inside a truck bed, the rear surface 132 of the plate 102 adheres to the truck bed. In the preferred embodiment, the thickness (indicated by letter “T”) of the metal plate 102 is about 3/16 inches and each side of the metal plate 102 is about 5 inches. The steel rod 120 has a uniform diameter of about 5/8 inches for enabling to snugly fit any conventional receiver hitch. It will be apparent to a person skilled in the art that the dimensions of any of the components of the vehicle receiver hitch stowage device 100 can be customized to meet requirements of different users.

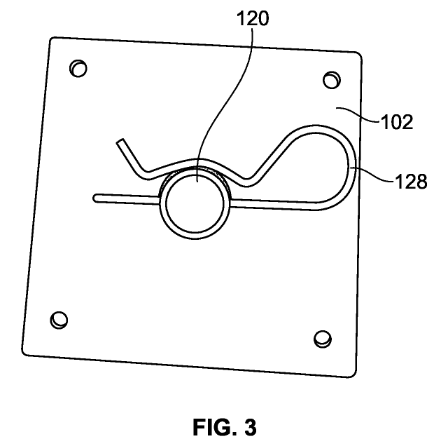

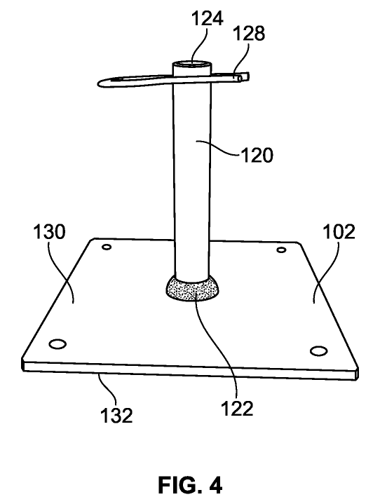

FIG. 3 and FIG. 4 illustrate a top perspective view and side perspective view of the vehicle receiver hitch stowage device 100 of the present invention in the assembled form according to an embodiment of the present invention. The hitch pin 128 is preferably 3 inches long and is M3X60mm hitch pin. The hitch pin 128 passes through the aperture 126 disposed in the steel rod 120 to secure the hitch receiver on the steel rod 120 and prevents from the lateral displacement thereof. It should be noted that the hitch pin 128 is easily accessible and can be pushed to insert through the aperture 126 and can be pulled to release the stored hitch receiver.

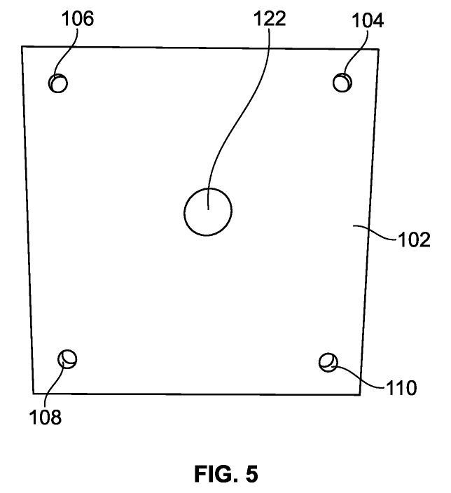

FIG. 5 illustrates a standalone view of the metal plate used in the vehicle receiver hitch stowage device 100 of the present invention. The metal plate 102 can have plane or textured surface and may come in different colors and designs. Each aperture 104,106,108,110 is circular and has a diameter of ¼”. Further, the apertures 104,106,108,110 are disposed at a distance of ½” inches from sides forming the vertex near which the corresponding aperture is disposed. The corners or vertices 112,114,116,118 of the metal plate 102 are preferably sharp but can also be rounded.

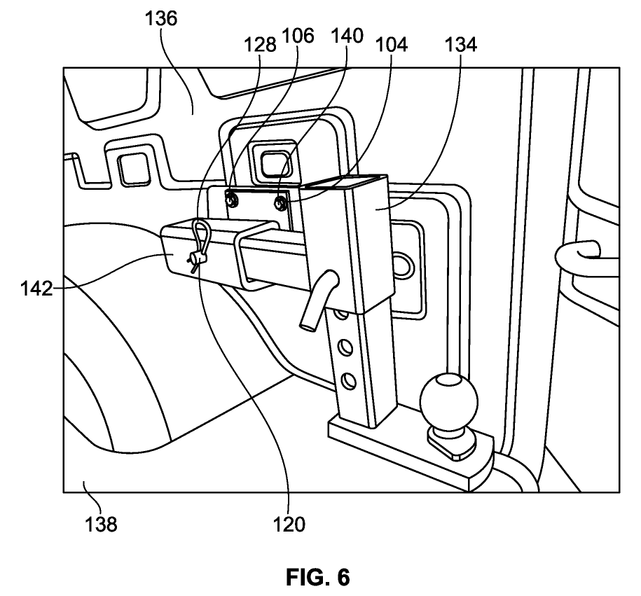

FIG. 6 illustrates a perspective view showing the vehicle receiver hitch stowage device 100 of the present invention in use for holding a receiver hitch inside a pick-up truck bed or car trunk in accordance with one embodiment. As illustrated, for holding the receiver hitch 134, the metal plate 102 is fastened to a side wall 136 of the truck bed 138 using a plurality of fasteners 140 wherein each fastener is passed through the apertures 104,106,108,110. When the metal plate 102 is fastened, the rear surface 132 adheres to the side wall 136 of the pick-up truck bed or car trunk. The hitch receiver tube 142 is accommodated on the perpendicular cylindrical steel rod 120 and the hitch pin 128 is passed through the aperture 126 for securing the receiver hitch 134. The vehicle receiver hitch stowage device 100 eliminates movement of the receiver hitch in the pick-up truck bed or car trunk when the vehicle moves and thereby prevents damage to the receiver hitch while also eliminating distraction to the driver.

FIG. 7 illustrates a flow chart depicting a process of using the vehicle receiver hitch stowage device 100 according to one embodiment of the present invention. Initially, the metal plate 102 is fastened to side wall of a pick-up truck bed or car trunk using the mechanical fasteners (Step 702). The fasteners can be removed to displace or remove the vehicle receiver hitch stowage device 100. Then, the steel rod 120 is welded to the front surface 130 of the metal plate 102 and is positioned perpendicular to the metal plate 102 (Step 704). It should be noted that the order of steps can be altered as per preferences of the users and design of the device 100. Thereafter, the receiver hitch is placed onto the device 100 such that the device 100 holds the receiver hitch securely in the truck bed or auto trunk where the receiver hitch is accessible to use (Step 706).

In different embodiments, the steel rod 120 may be welded to the metal plate 102 using one or more of stick welding, gas metal arc welding, gas tungsten arc welding, laser beam welding, or electronic beam welding.

A description of an embodiment with several components in communication with each other does not imply that all such components are required. On the contrary, a variety of optional components are described to illustrate the wide variety of possible embodiments of the disclosure. Further, there are other components also present in the substation communication network, however, these are not presented in the description to focus on the main features of the invention.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A vehicle receiver hitch stowage device, comprising
a planar metal plate having a plurality of apertures disposed therein, the apertures
configured to receive mechanical fasteners for securing the plate to a vehicle surface;
a shaft extending from the housing; and
a cylindrical rod attached perpendicularly to a center point of the metal plate, the rod having
an aperture near the proximal end thereof for receiving a hitch pin to secure a receiver hitch.

2. The vehicle receiver hitch stowage device of claim 1, wherein the cylindrical rod is welded to the metal plate.

3. The vehicle receiver hitch stowage device of claim 1, wherein the metal plate is made of carbon steel.

4. The vehicle receiver hitch stowage device of claim 1, wherein the metal plate is fastened to a truck bed or car trunk using bolts passed through the plurality of apertures.

5. The vehicle receiver hitch stowage device of claim 1, wherein the cylindrical rod has a length of about 4 inches.

6. The vehicle receiver hitch stowage device of claim 1, wherein the corners of the metal plate are rounded.

7. A vehicle receiver hitch stowage device for storing a receiver hitch in a vehicle, comprising;
a rectangular steel plate having a thickness of about 3/16 inches, each side measuring about 5 inches, and a plurality of circular apertures each with a diameter of ¼ inch disposed ½ inch from the sides forming the vertices of the plate; and
a cylindrical steel rod welded to the center of the plate, the rod having a length of about 4 inches, a diameter of about 5/8 inches, and an aperture disposed near the proximal end thereof for receiving an M3X60mm hitch pin to secure a receiver hitch.

8. The vehicle receiver hitch stowage device of claim 7, wherein the cylindrical rod is welded to the metal plate using gas metal arc welding or laser beam welding.

9. The vehicle receiver hitch stowage device of claim 7, wherein the rectangular steel plate has a textured surface to enhance grip and reduce slippage when installed.

10. A method of storing a receiver hitch using a vehicle receiver hitch stowage device, comprising;
fastening a planar metal plate with a plurality of apertures to a side wall of a vehicle using a plurality of mechanical fasteners;
attaching a cylindrical rod perpendicularly to the center of the metal plate;
placing the receiver hitch onto the cylindrical rod; and
securing the receiver hitch by passing a hitch pin through an aperture near the proximal end of the cylindrical rod.

11. The method of storing a receiver hitch using a vehicle receiver hitch stowage device of claim 10, further comprising the step of removing the mechanical fasteners to displace or remove the vehicle receiver hitch stowage device from the vehicle.

12. The method of storing a receiver hitch using a vehicle receiver hitch stowage device of claim 10, wherein the step of attaching the cylindrical rod to the metal plate comprises welding the rod to the plate using one of stick welding, gas metal arc welding, gas tungsten arc welding, laser beam welding, or electron beam welding.
